(19) United States
(12) Patent Application Publication
(10) Pub. No.: US 2025/0124332 A1
(43) Pub. Date: Apr. 17, 2025

(54) METHOD AND SYSTEM FOR SUPERVISED GENERATIVE OPTIMIZATION FOR SYNTHETIC DATA GENERATION

(71) Applicant: JPMorgan Chase Bank, N.A., New York, NY (US)

(72) Inventors: Shinpei NAKAMURA SAKAI, New Haven, CT (US); Fadi HAMAD, Pittsburgh, PA (US); Saheed OBITAYO, New York, NY (US); Vamsi Krishna POTLURU, New York, NY (US)

(73) Assignee: JPMorgan Chase Bank, N.A., New York, NY (US)

(21) Appl. No.: 18/379,040

(22) Filed: Oct. 11, 2023

(51) Int. Cl. G06N 20/00

(52) U.S. Cl. CPC G06N 20/00

(57) ABSTRACT

A method for facilitating supervised generative optimization for synthetic data generation is disclosed. The method includes receiving, via an application programming interface, inputs that include input data and parameters; partitioning the input data to generate data sets, the data sets including training data sets, validation data sets, and test data sets; tuning hyperparameters of synthesizers by using the data sets and supervised optimization that is based on downstream performance metrics; determining a mixture distribution from among the tuned synthesizers; training machine learning models based on the mixture distribution; and generating, by using the trained machine learning models, sets of synthetic data based on the input data.

### BACKGROUND

### 1. Field of the Disclosure

This technology generally relates to methods and systems for synthetic data generation, and more particularly to methods and systems for providing a supervised generative optimization framework that leverages a supervised component and a meta-learning approach to facilitate synthetic data generation.

### 2. Background Information

Many business entities utilize machine learning and artificial intelligence processes that leverage large collections of data to forecast potential outcomes and identify actionable intelligence for decision makers. Often, synthetically generated representative data are used in place of these large collections of data to enable testing of new ideas without compromising real-world data as well as permit blending of multiple data sources. Historically, implementations of conventional synthetic data generation techniques have resulted in varying degrees of success with respect to preserving statistical properties and relations with the original data.

One drawback of using the conventional synthetic data generation techniques is that in many instances, utility degradation depends on fidelity of the data generation process and the downstream task. As a result, usage of synthetic data may cause performance degradation in modeling. Additionally, while many algorithms have been proposed for synthetic data generation, a majority of existing approaches are unsupervised and do not take into account downstream tasks.

Therefore, there is a need for a supervised generative optimization framework that integrates a supervised component tailored to specific downstream tasks as well as employs a meta-learning approach that identifies optimal mixture distributions from outputs of existing synthetic generation algorithms.

### SUMMARY

The present disclosure, through one or more of its various aspects, embodiments, and/or specific features or sub-components, provides, inter alia, various systems, servers, devices, methods, media, programs, and platforms for providing a supervised generative optimization framework that leverages a supervised component and a meta-learning approach to facilitate synthetic data generation.

According to an aspect of the present disclosure, a method for facilitating supervised generative optimization for synthetic data generation is disclosed. The method is implemented by at least one processor. The method may include receiving, via an application programming interface, at least one input, each of the at least one input may include input data and at least one parameter; partitioning the input data to generate at least one data set, the at least one data set may include at least one from among a training data set, a validation data set, and a test data set; tuning at least one hyperparameter of at least one synthesizer by using the at least one data set and supervised optimization that is based on at least one downstream performance metric; determining a mixture distribution from among the tuned at least one synthesizer; training at least one model based on the mixture distribution; and generating, by using the trained at least one model, at least one set of synthetic data based on the input data.

In accordance with an exemplary embodiment, the input data may include at least one collection of tabular data for synthesis according to the at least one parameter, the at least one parameter may include a number of tabular rows for the synthesis.

In accordance with an exemplary embodiment, the at least one hyperparameter may be tuned based on the at least one downstream performance metric and at least one regularization parameter, the at least one regularization parameter may include at least one from among a privacy regularization, a fidelity regularization, and an efficacy regularization.

In accordance with an exemplary embodiment, each of the at least one synthesizer may correspond to a synthetic data generator that uses a synthetic data generation algorithm to identify at least one property of sampled data, the at least one property may include at least one from among a correlation, a distribution, and a pattern.

In accordance with an exemplary embodiment, the mixture distribution may correspond to an automatically determined composition of at least one variable that is derived from output of each of the tuned at least one synthesizer, the at least one variable may include a random variable.

In accordance with an exemplary embodiment, to tune the at least one hyperparameter of the at least one synthesizer, the method may further include optimizing at least one target function that corresponds to each of the at least one synthesizer, wherein the optimizing may relate to a bi-level optimization of the at least one target function.

In accordance with an exemplary embodiment, to optimize the at least one target function, the method may further include minimizing at least one validation loss function that corresponds to each of the at least one synthesizer based on the validation data set; and minimizing at least one training loss function that corresponds to each of the at least one synthesizer based on the training data set.

In accordance with an exemplary embodiment, the method may further include augmenting the input data by incorporating the generated at least one set of synthetic data into the input data, wherein the input data may be augmented for the at least one downstream performance metric for a corresponding downstream task.

In accordance with an exemplary embodiment, each of the at least one synthesizer and the at least one model may include at least one from among a deep learning model, a neural network model, a machine learning model, a mathematical model, and a process model.

According to an aspect of the present disclosure, a computing device configured to implement an execution of a method for facilitating supervised generative optimization for synthetic data generation is disclosed. The computing device including a processor; a memory; and a communication interface coupled to each of the processor and the memory, wherein the processor may be configured to receive, via an application programming interface, at least one input, each of the at least one input may include input data and at least one parameter; partition the input data to generate at least one data set, the at least one data set may include at least one from among a training data set, a validation data set, and a test data set; tune at least one hyperparameter of at least one synthesizer by using the at least one data set and supervised optimization that is based on at least one downstream performance metric; determine a mixture distribution from among the tuned at least one synthesizer; train at least one model based on the mixture distribution; and generate, by using the trained at least one model, at least one set of synthetic data based on the input data.

In accordance with an exemplary embodiment, the input data may include at least one collection of tabular data for synthesis according to the at least one parameter, the at least one parameter may include a number of tabular rows for the synthesis.

In accordance with an exemplary embodiment, the processor may be further configured to tune the at least one hyperparameter based on the at least one downstream performance metric and at least one regularization parameter, the at least one regularization parameter may include at least one from among a privacy regularization, a fidelity regularization, and an efficacy regularization.

In accordance with an exemplary embodiment, each of the at least one synthesizer may correspond to a synthetic data generator that uses a synthetic data generation algorithm to identify at least one property of sampled data, the at least one property may include at least one from among a correlation, a distribution, and a pattern.

In accordance with an exemplary embodiment, the mixture distribution may correspond to an automatically determined composition of at least one variable that is derived from output of each of the tuned at least one synthesizer, the at least one variable may include a random variable.

In accordance with an exemplary embodiment, to tune the at least one hyperparameter of the at least one synthesizer, the processor may be further configured to optimize at least one target function that corresponds to each of the at least one synthesizer, wherein the optimizing may relate to a bi-level optimization of the at least one target function.

In accordance with an exemplary embodiment, to optimize the at least one target function, the processor may be further configured to minimize at least one validation loss function that corresponds to each of the at least one synthesizer based on the validation data set; and minimize at least one training loss function that corresponds to each of the at least one synthesizer based on the training data set.

In accordance with an exemplary embodiment, the processor may be further configured to augment the input data by incorporating the generated at least one set of synthetic data into the input data, wherein the input data may be augmented for the at least one downstream performance metric for a corresponding downstream task.

In accordance with an exemplary embodiment, each of the at least one synthesizer and the at least one model may include at least one from among a deep learning model, a neural network model, a machine learning model, a mathematical model, and a process model.

According to an aspect of the present disclosure, a non-transitory computer readable storage medium storing instructions for facilitating supervised generative optimization for synthetic data generation is disclosed. The storage medium including executable code which, when executed by a processor, may cause the processor to receive, via an application programming interface, at least one input, each of the at least one input may include input data and at least one parameter; partition the input data to generate at least one data set, the at least one data set may include at least one from among a training data set, a validation data set, and a test data set; tune at least one hyperparameter of at least one synthesizer by using the at least one data set and supervised optimization that is based on at least one downstream performance metric; determine a mixture distribution from among the tuned at least one synthesizer; train at least one model based on the mixture distribution; and generate, by using the trained at least one model, at least one set of synthetic data based on the input data.

In accordance with an exemplary embodiment, the input data may include at least one collection of tabular data for synthesis according to the at least one parameter, the at least one parameter may include a number of tabular rows for the synthesis.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing a supervised generative optimization framework that leverages a supervised component and a meta-learning approach to facilitate synthetic data generation.

FIG. 4 is a flowchart of an exemplary process for implementing a method for providing a supervised generative optimization framework that leverages a supervised component and a meta-learning approach to facilitate synthetic data generation.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

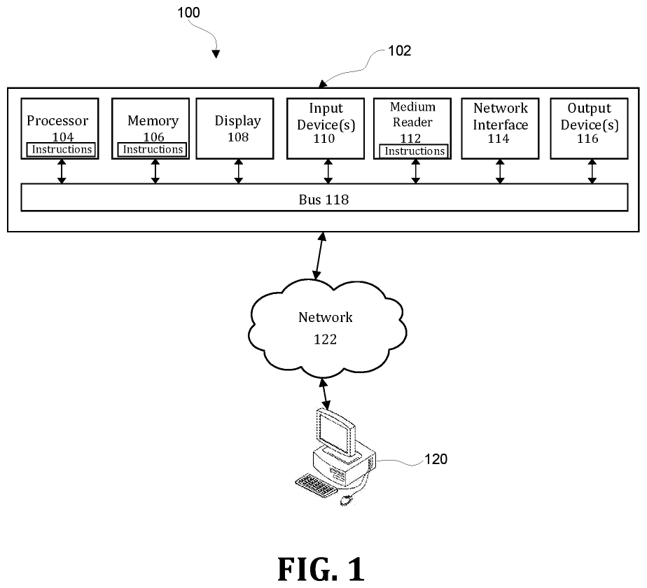

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning system (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons skilled in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a GPS device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing a supervised generative optimization framework that leverages a supervised component and a meta-learning approach to facilitate synthetic data generation.

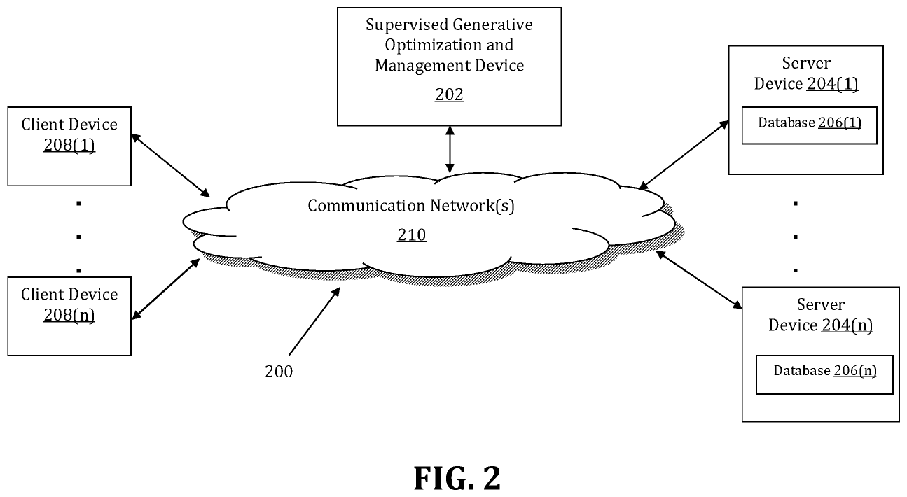

Referring to FIG. 2, a schematic of an exemplary network environment 200 for implementing a method for providing a supervised generative optimization framework that leverages a supervised component and a meta-learning approach to facilitate synthetic data generation is illustrated. In an exemplary embodiment, the method is executable on any networked computer platform, such as, for example, a personal computer (PC).

The method for providing a supervised generative optimization framework that leverages a supervised component and a meta-learning approach to facilitate synthetic data generation may be implemented by a Supervised Generative Optimization and Management (SGOM) device 202. The SGOM device 202 may be the same or similar to the computer system 102 as described with respect to FIG. 1. The SGOM device 202 may store one or more applications that can include executable instructions that, when executed by the SGOM device 202, cause the SGOM device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the SGOM device 202 itself, may be located in virtual server(s) running in a cloud-based computing environment rather than being tied to one or more specific physical network computing devices. Also, the application(s) may be running in one or more virtual machines (VMs) executing on the SGOM device 202. Additionally, in one or more embodiments of this technology, virtual machine(s) running on the SGOM device 202 may be managed or supervised by a hypervisor.

In the network environment 200 of FIG. 2, the SGOM device 202 is coupled to a plurality of server devices 204(1)-204(n) that hosts a plurality of databases 206(1)-206(n), and also to a plurality of client devices 208(1)-208(n) via communication network(s) 210. A communication interface of the SGOM device 202, such as the network interface 114 of the computer system 102 of FIG. 1, operatively couples and communicates between the SGOM device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the SGOM device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and SGOM devices that efficiently implement a method for providing a supervised generative optimization framework that leverages a supervised component and a meta-learning approach to facilitate synthetic data generation.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The SGOM device 202 may be a standalone device or integrated with one or more other devices or apparatuses, such as one or more of the server devices 204(1)-204(n), for example. In one particular example, the SGOM device 202 may include or be hosted by one of the server devices 204(1)-204(n), and other arrangements are also possible. Moreover, one or more of the devices of the SGOM device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the SGOM device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to input data, parameters, training data sets, validation data sets, test data sets, hyperparameters, synthesizers downstream performance metrics, mixture distributions, machine learning models, and synthetic data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the SGOM device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the SGOM device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the SGOM device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the SGOM device 202, the server devices 204(1)-204(n), or the client devices 208(1)-208(n), for example, may be configured to operate as virtual instances on the same physical machine. In other words, one or more of the SGOM device 202, the server devices 204(1)-204(n), or the client devices 208(1)-208(n) may operate on the same physical device rather than as separate devices communicating through communication network(s) 210. Additionally, there may be more or fewer SGOM devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

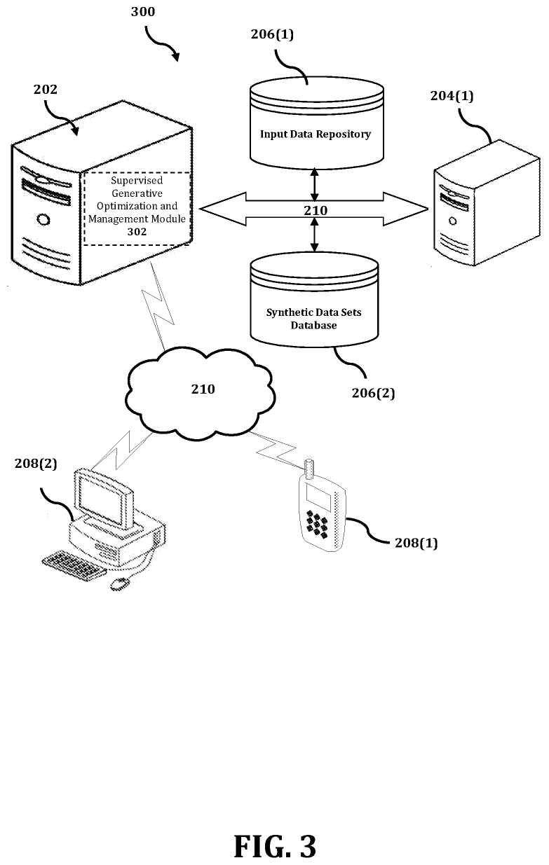

The SGOM device 202 is described and shown in FIG. 3 as including a supervised generative optimization and management module 302, although it may include other rules, policies, modules, databases, or applications, for example. As will be described below, the supervised generative optimization and management module 302 is configured to implement a method for providing a supervised generative optimization framework that leverages a supervised component and a meta-learning approach to facilitate synthetic data generation.

An exemplary process 300 for implementing a mechanism for providing a supervised generative optimization framework that leverages a supervised component and a meta-learning approach to facilitate synthetic data generation by utilizing the network environment of FIG. 2 is shown as being executed in FIG. 3. Specifically, a first client device 208(1) and a second client device 208(2) are illustrated as being in communication with SGOM device 202. In this regard, the first client device 208(1) and the second client device 208(2) may be “clients” of the SGOM device 202 and are described herein as such. Nevertheless, it is to be known and understood that the first client device 208(1) and/or the second client device 208(2) need not necessarily be “clients” of the SGOM device 202, or any entity described in association therewith herein. Any additional or alternative relationship may exist between either or both of the first client device 208(1) and the second client device 208(2) and the SGOM device 202, or no relationship may exist.

Further, SGOM device 202 is illustrated as being able to access an input data repository 206(1) and a synthetic data sets database 206(2). The supervised generative optimization and management module 302 may be configured to access these databases for implementing a method for providing a supervised generative optimization framework that leverages a supervised component and a meta-learning approach to facilitate synthetic data generation.

The first client device 208(1) may be, for example, a smart phone. Of course, the first client device 208(1) may be any additional device described herein. The second client device 208(2) may be, for example, a PC. Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the SGOM device 202 via broadband or cellular communication. Of course, these embodiments are merely exemplary and are not limiting or exhaustive.

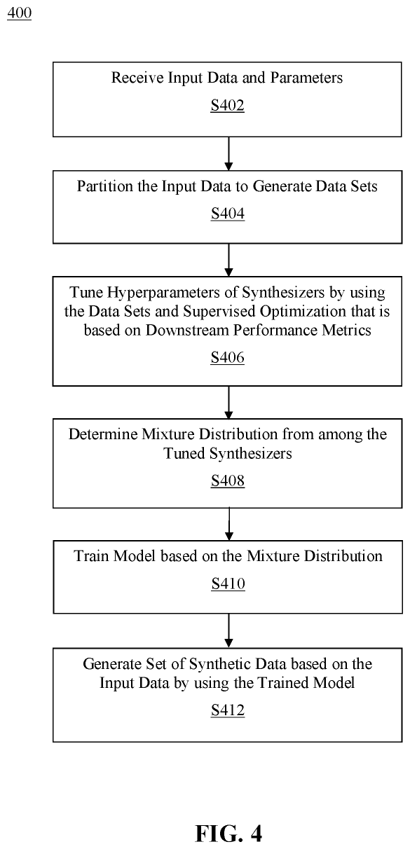

Upon being started, the supervised generative optimization and management module 302 executes a process for providing a supervised generative optimization framework that leverages a supervised component and a meta-learning approach to facilitate synthetic data generation. An exemplary process for providing a supervised generative optimization framework that leverages a supervised component and a meta-learning approach to facilitate synthetic data generation is generally indicated at flowchart 400 in FIG. 4.

In the process 400 of FIG. 4, at step S402, inputs may be received via an application programming interface. The inputs may include input data and corresponding parameters. In an exemplary embodiment, the input data may include collections of tabular data. The tabular data may relate to real-world data such as, for example, sensitive health data that requires privacy protection. The tabular data may be aggregated from various industries such as, for example, financial industries, telecommunication industries, and healthcare industries where data-driven decision making is crucial.

In another exemplary embodiment, the input data may be received as at least one from among formatted data and raw data. The formatted data may be received in a desired data format for further processing consistent with present disclosures. The raw data may be received in an original data format and require additional processing steps to convert into the desired data format for further processing consistent with present disclosures. The input data may include any combination of alphabetic, numeric, and symbolic characters that are organized according to any computing file format.

In another exemplary embodiment, the input data may include collections of tabular data for synthesis according to the parameters. The synthesis process may relate to the generation of synthetic data that are usable in place of the input data. The synthetic data may correspond to information that has been artificially generated rather than created by real-world events. The synthetic data may be generated algorithmically consistent with present disclosures. The synthetic data may be usable as a stand-in for real-world data to validate as well as to train machine learning models.

In another exemplary embodiment, the parameters may include predetermined criteria such as, for example, a number of tabular rows for the synthesis process. The parameters may be predetermined for each set of input data. The parameters may be associated with a corresponding set of input data to facilitate processing consistent with present disclosures. As used in the present disclosures, the parameters may reference both input parameters such as, for example, the number of tabular rows desired in the synthetic data as well as modeling parameters.

Consistent with present disclosures, to facilitate synthetic data generation, M={GC, CTGAN, C-GAN, TVAE} may be defined as the set of synthetic data generation methods utilized. Here, GC, CTGAN, C-GAN, and TVAE are merely used as variables for exemplary purposes and do not have independent meaning outside of the present disclosure. For each method m∈M, there may be a corresponding synthetic data generation function Sm (N; ωm; θm) where N is the number of rows to simulate, ωm is the set of parameters, and θm is the set of hyper-parameters.

Dreal may represent the real data set and Dm may denote the synthetic data generated by model m∈M. Additionally, consistent with present disclosures, three data sets: Dtrain, Dval, and Dtest, representing the training, validation, and testing data sets, respectively, may be generated. All D* may have an outcome vector and covariate matrix which could be represented as duplet D*=(X*,Y*). The downstream loss function may be defined as L(Y,Y\hat{ }) where Y\hat{ } is the outcome predicted by the downstream prediction function μ=ƒ(Y˜X), where ƒ(Y˜X) is the notation for a regression estimator but ƒ can be any machine learning estimator and μ denotes the learned function. Additionally, when μ is learned from the synthetic data generated by Sm (N; ωm;θm), it may be denoted as μω (θm)=ƒ(Ym, Xm) where (Xm,Ym)=Sm (N; ωm;θm).

At step S404, the input data may be partitioned to generate data sets. The data sets may include at least one from among a training data set, a validation data set, and a test data set. In an exemplary embodiment, data partitioning may relate to a process for dividing the input data into smaller, non-overlapping subsets. The subsets may be usable to train, validate, and test machine learning models. The division of the input data may enable a more accurate evaluation of model performance and help prevent over fitting. For especially large sets of input data, a portion of the input data may be selected for the partitioning. In another exemplary embodiment, the partitioning process may be used to split the input data prior to use with any machine learning model to ensure that there is data available to assess the model. The partitioning process may retain a subset of available data out of analysis for later use to verify the model.

At step S406, hyperparameters of various synthesizers may be tuned by using the data sets. The tuning process may relate to a supervising synthesizers step that involves tuning of the hyperparameters by using an optimization approach that is supervised by the downstream performance metrics. In an exemplary embodiment, the synthesizers may correspond to synthetic data generators that use a synthetic data generation algorithm such as, for example, a machine learning algorithm to identify properties of sampled data. The properties may include at least one from among a correlation, a distribution, and a pattern.

In another exemplary embodiment, the hyperparameters may relate to external configuration variables that are usable to manage machine learning model training. The hyperparameters may be set prior to model training to directly control model structure, function, and performance. Consistent with present disclosures, the hyperparameters may be tuned by using the data sets and supervised optimization that is based on downstream performance metrics.

In another exemplary embodiment, the hyperparameters may be tuned based on the downstream performance metrics and regularization parameters. Consistent with present disclosures, regularization may relate to various techniques that are usable to calibrate machine learning models in order to minimize the adjusted loss function and prevent overfitting or underfitting. By using the regularization, the machine learning models may be appropriately fit according to the regularization parameters for a given test set to reduce errors. The regularization parameters may include at least one from among a privacy regularization, a fidelity regularization, and an efficacy regularization.

In another exemplary embodiment, the hyperparameters of the synthesizers may be tuned by optimizing target functions that correspond to each of the synthesizers. The optimizing may relate to a bi-level optimization of the target functions. Consistent with present disclosures, the optimizing of the target functions may include minimizing validation loss functions that correspond to each of the synthesizers based on the validation data set. Similarly, training loss functions that correspond to each of the synthesizers may also be minimized based on the training data set.

In another exemplary embodiment, the optimization formulation may be given as bi-level optimization problems. To solve these hyperparameter tuning optimization problems, an optimization approach such as, for example, a Bayesian optimization approach may be utilized. The flexibility of Bayesian hyperparameter tuning may allow for efficient switching of target functions to optimize. Moreover, the option to incorporate privacy and/or fidelity regularization may be afforded by using the Bayesian optimization approach in addition to the downstream task.

Consistent with present disclosures, the supervising synthesizer optimization problem using bi-level formulation may be given by:

$${θ}^{*} = {arg min}_{θ} ℒ ( {Y}_{val} , {\hat{Y}}_{val} ) \\ s . t . {\hat{Y}}_{val} := {\hat{μ}}_{{ω}^{*} ( θ )} ( {X}_{val} ) \qquad ( 1 )$$

$$st$$

$${ω}^{*} ( θ ) = {arg min}_{ω} ℱ ( ω , θ , {D}_{train} ) , \qquad ( 2 )$$

Where the outer optimization problem (1) may be minimizing the loss function on the validation set Dval, and the inner optimization problem (2) may be minimizing the loss function denoted by F on the training set Dtrain for synthesizer model S. Note that these functions, L and F, are not necessarily the same and may be measured on different models. For example, F always refers to the loss function used during the training of the synthesizer model S, whereas L refers to the model's performance on the validation set, possibly employing a different evaluation metric. Alternatively, L may also refer to the loss function for the downstream task performed by model ƒ.

Unlike traditional processes, the optimization approach disclosed in the present application may construct a probabilistic model around involved parameters. Subsequently, these parameters may be updated based on the evaluation performance of the loss function. To establish the prior/posterior distribution over the objective function, an estimator such as, for example, a Parzen-Tree Estimator may be employed. The estimator may enable effective location of the parameter space's optimal region, which maximizes the expected improvement in the loss function. By employing optimization processes in this manner, the synthesizer models may be efficiently fine-tuned to enhance overall performance in generating data that closely resembles the real data set as well as boosting the downstream performance.

In another exemplary embodiment, the synthesizers may include at least one from among a deep learning model, a neural network model, a machine learning model, a mathematical model, a process model, and a data model. The synthesizers may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, etc. In another exemplary embodiment, machine learning analytical techniques may include unsupervised learning algorithms such as, for example, Apriori algorithm analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the machine learning process may include a neural network that relates to at least one from among an artificial neural network and a simulated neural network. The neural network may correspond to a technique in artificial intelligence that teaches computers to process data by using interconnected processing nodes and/or artificial neurons. The neural network may relate to a type of machine learning such as, for example, deep learning that uses interconnected nodes and/or artificial neurons in a layered structure to transform inputs for predictive analytics.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

At step S408, mixture distributions may be determined from among the tuned synthesizers. The determination process may relate to a composing synthesizers step that utilizes a meta-learning approach to determine the mixture distribution among the synthesizers in M. The meta-learning approach may learn the final model from the models obtained in previous steps. In an exemplary embodiment, the mixture distributions may correspond to an automatically determined composition of variables that are derived from outputs of the tuned synthesizers. Consistent with present disclosures, the variables may include random variables.

At step S410, models may be trained based on the mixture distributions. In an exemplary embodiment, consistent with present disclosures, the models may include at least one from among a deep learning model, a neural network model, a machine learning model, a mathematical model, a process model, and a data model.

In another exemplary embodiment, consistent with present disclosures for each synthesizer m∈M, αm∈[0, 1] may be defined as the proportion of the total observations sampled from Sm. The final synthetic data may comprise [αmN] observations for each m, where [⋅] denotes the closest integer function. The formulation of this meta-learning approach using an optimization framework may be given in (3). Note that the θm may be the default parameters of each m∈M or the tuned parameter obtained in a supervising step.

The meta-learning optimization formulation may be given by:

$${α}^{*} = {arg min}_{α ∈ {ℛ}^{[ M ]}} ℒ ( {Y}_{val} , {\hat{Y}}_{val} ) \\ s . t ( {X}_{syn}^{m} , {Y}_{syn}^{m} ) = {S}_{m} ( [ {α}_{m} N ] , {θ}_{m} ) ∀ m ∈ M \\ {X}_{syn} = {[ {( {X}_{syn}^{m} )}^{T} : m ∈ M ]}^{T} \\ {Y}_{syn} = [ {Y}_{syn}^{m} : m ∈ M ] \\ \hat{μ} = f ( {Y}_{syn} , {X}_{syn} ) \\ {\hat{Y}}_{val} := \hat{μ} ( {X}_{val} ) , \qquad ( 3 )$$

Where L may refer to the loss function of the downstream task on the validation set Dval, which is usable to evaluate the quality of the a's that is generated by an optimization process at each iteration. This evaluation process may involve evaluating the downstream task performance on the combined synthetic data generated by using different synthetic data generation techniques.

At step S412, synthetic data sets may be generated by using the trained models based on the input data. Consistent with present disclosures, synthetic data sets that are tailored to the specific downstream tasks may be generated by using the trained models which learned the optimal mixture distribution of existing synthetic data generation processes. The synthetic data sets may correspond to information that has been artificially generated rather than created by real-world events. The synthetic data sets may be generated algorithmically consistent with present disclosures. The synthetic data sets may be usable as a stand-in for real-world data to validate as well as to train machine learning models.

In an exemplary embodiment, the synthetic data sets may be generated based on a mixture of multiple synthetic data generation methods. From each of the learned methods, multiple data generation techniques may be explored to tune the proportion of data sets sampled. This approach may discover the projection of the true underlying data distribution onto the set encompassing various synthesizers. Employing supervised optimization, the ideal mixture that optimizes the downstream performance metric may be identified. By dynamically combining the strengths of different data generation methods, the overall synthetic data quality and its suitability for downstream tasks may be enhanced.

In another exemplary embodiment, the synthetic data sets may be incorporated into the input data to improve downstream processes. To facilitate the improvements, the input data may be augmented by incorporating the generated synthetic data sets into the input data. The input data may be augmented for the downstream performance metrics for a corresponding downstream task.

In another exemplary embodiment, data augmentation by using the synthetic data sets may correspond to techniques for artificially increasing the input data by synthetically generating new input data based on the existing input data. That is, the data augmentation process may artificially increase an amount of data by generating new data points from existing data to amplify a given data set. The data augmentation process may reduce overfitting when training machine learning models by training the models on several modified copies of existing data.

In another exemplary embodiment, a quality of the generated synthetic data may be assessed. To evaluate the synthetic data generation models for tabular data, various benchmarking approaches may be implemented to allow for flexibility in adapting the loss function to suit specific objectives of synthetic data generation. In order to evaluate the accuracy of preserving individual attributes and attribute pairs in synthetic data, test such as, for example, the Kolmogorov-Smirnov (KS) Test and Chi-Squared (CS) Test may be employed. The KS Test may compare continuous column distributions using the empirical distribution function, while the CS Test may compare discrete column distributions using the Chi-Squared distribution. Additionally, fidelity may be assessed by building a machine learning classifier to differentiate between real and synthetic data.

Accordingly, with this technology, an optimized process for providing a supervised generative optimization framework that leverages a supervised component and a meta-learning approach to facilitate synthetic data generation is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for facilitating supervised generative optimization for synthetic data generation, the method being implemented by at least one processor, the method comprising:
receiving, by the at least one processor via an application programming interface, at least one input, each of the at least one input including input data and at least one parameter;
partitioning, by the at least one processor, the input data to generate at least one data set, the at least one data set including at least one from among a training data set, a validation data set, and a test data set;
tuning, by the at least one processor, at least one hyperparameter of at least one synthesizer by using the at least one data set and supervised optimization that is based on at least one downstream performance metric;
determining, by the at least one processor, a mixture distribution from among the tuned at least one synthesizer;
training, by the at least one processor, at least one model based on the mixture distribution; and
generating, by the at least one processor using the trained at least one model, at least one set of synthetic data based on the input data.

2. The method of claim 1, wherein the input data includes at least one collection of tabular data for synthesis according to the at least one parameter, the at least one parameter including a number of tabular rows for the synthesis.

3. The method of claim 1, wherein the at least one hyperparameter is tuned based on the at least one downstream performance metric and at least one regularization parameter, the at least one regularization parameter including at least one from among a privacy regularization, a fidelity regularization, and an efficacy regularization.

4. The method of claim 1, wherein each of the at least one synthesizer corresponds to a synthetic data generator that uses a synthetic data generation algorithm to identify at least one property of sampled data, the at least one property including at least one from among a correlation, a distribution, and a pattern.

5. The method of claim 1, wherein the mixture distribution corresponds to an automatically determined composition of at least one variable that is derived from output of each of the tuned at least one synthesizer, the at least one variable including a random variable.

6. The method of claim 1, wherein the tuning of the at least one hyperparameter of the at least one synthesizer further comprises:
optimizing, by the at least one processor, at least one target function that corresponds to each of the at least one synthesizer,
wherein the optimizing relates to a bi-level optimization of the at least one target function.

7. The method of claim 6, wherein the optimizing of the at least one target function further comprises:
minimizing, by the at least one processor, at least one validation loss function that corresponds to each of the at least one synthesizer based on the validation data set; and
minimizing, by the at least one processor, at least one training loss function that corresponds to each of the at least one synthesizer based on the training data set.

8. The method of claim 1, further comprising:
augmenting, by the at least one processor, the input data by incorporating the generated at least one set of synthetic data into the input data,
wherein the input data is augmented for the at least one downstream performance metric for a corresponding downstream task.

9. The method of claim 1, wherein each of the at least one synthesizer and the at least one model includes at least one from among a deep learning model, a neural network model, a machine learning model, a mathematical model, and a process model.

10. A computing device configured to implement an execution of a method for facilitating supervised generative optimization for synthetic data generation, the computing device comprising:
a processor;
a memory; and
a communication interface coupled to each of the processor and the memory,
wherein the processor is configured to:
receive, via an application programming interface, at least one input, each of the at least one input including input data and at least one parameter;
partition the input data to generate at least one data set, the at least one data set including at least one from among a training data set, a validation data set, and a test data set;
tune at least one hyperparameter of at least one synthesizer by using the at least one data set and supervised optimization that is based on at least one downstream performance metric;
determine a mixture distribution from among the tuned at least one synthesizer;
train at least one model based on the mixture distribution; and
generate, by using the trained at least one model, at least one set of synthetic data based on the input data.

11. The computing device of claim 10, wherein the input data includes at least one collection of tabular data for synthesis according to the at least one parameter, the at least one parameter including a number of tabular rows for the synthesis.

12. The computing device of claim 10, wherein the processor is further configured to tune the at least one hyperparameter based on the at least one downstream performance metric and at least one regularization parameter, the at least one regularization parameter including at least one from among a privacy regularization, a fidelity regularization, and an efficacy regularization.

13. The computing device of claim 10, wherein each of the at least one synthesizer corresponds to a synthetic data generator that uses a synthetic data generation algorithm to identify at least one property of sampled data, the at least one property including at least one from among a correlation, a distribution, and a pattern.

14. The computing device of claim 10, wherein the mixture distribution corresponds to an automatically determined composition of at least one variable that is derived from output of each of the tuned at least one synthesizer, the at least one variable including a random variable.

15. The computing device of claim 10, wherein, to tune the at least one hyperparameter of the at least one synthesizer, the processor is further configured to:
optimize at least one target function that corresponds to each of the at least one synthesizer,
wherein the optimizing relates to a bi-level optimization of the at least one target function.

16. The computing device of claim 15, wherein, to optimize the at least one target function, the processor is further configured to:
minimize at least one validation loss function that corresponds to each of the at least one synthesizer based on the validation data set; and
minimize at least one training loss function that corresponds to each of the at least one synthesizer based on the training data set.

17. The computing device of claim 10, wherein the processor is further configured to:
augment the input data by incorporating the generated at least one set of synthetic data into the input data,
wherein the input data is augmented for the at least one downstream performance metric for a corresponding downstream task.

18. The computing device of claim 10, wherein each of the at least one synthesizer and the at least one model includes at least one from among a deep learning model, a neural network model, a machine learning model, a mathematical model, and a process model.

19. A non-transitory computer readable storage medium storing instructions for facilitating supervised generative optimization for synthetic data generation, the storage medium comprising executable code which, when executed by a processor, causes the processor to:
receive, via an application programming interface, at least one input, each of the at least one input including input data and at least one parameter;
partition the input data to generate at least one data set, the at least one data set including at least one from among a training data set, a validation data set, and a test data set;
tune at least one hyperparameter of at least one synthesizer by using the at least one data set and supervised optimization that is based on at least one downstream performance metric;
determine a mixture distribution from among the tuned at least one synthesizer;
train at least one model based on the mixture distribution; and
generate, by using the trained at least one model, at least one set of synthetic data based on the input data.

20. The storage medium of claim 19, wherein the input data includes at least one collection of tabular data for synthesis according to the at least one parameter, the at least one parameter including a number of tabular rows for the synthesis.
